(19) United States
(12) Patent Application Publication
(10) Pub. No.: US 2025/0224561 A1
(43) Pub. Date: Jul. 10, 2025

(54) OPTICAL WAVEGUIDE COUPLER AND FABRICATION METHOD THEREFOR

(71) Applicant: NANTONG NANLITAI TECHNOLOGY CO., LTD., Nantong (CN)

(72) Inventor: Fang Bo, Tianjin (CN)

(73) Assignee: NANTONG NANLITAI TECHNOLOGY CO., LTD., Nantong (CN)

(21) Appl. No.: 18/852,802

(22) PCT Filed: Sep. 16, 2022
(86) PCT No.: PCT/CN2022/119226

§ 371 Date: Sep. 30, 2024

(30) Foreign Application Priority Data
Mar. 31, 2022 (CN) 202210335051.4

(51) Int. Cl. G02B 6/122; G02B 6/12; G02B 6/136

(52) U.S. Cl. CPC G02B 6/1228; G02B 6/136; G02B 2006/12147

(57) ABSTRACT

An optical waveguide coupler includes a substrate, a high-refractive-index waveguide, and a low-refractive-index waveguide. The high-refractive-index waveguide is formed on the substrate and includes a first waveguiding segment and a second waveguiding segment that are sequentially connected to each other and extend along a first direction. Along the first direction, the thickness of the second waveguiding segment gradually decreases. The low-refractive-index waveguide is formed on the substrate and covers the high-refractive-index waveguide. The refractive index of the low-refractive-index waveguide is greater than the refractive index of an isolation layer of the substrate and less than the refractive index of the high-refractive-index waveguide, and the low-refractive-index waveguide is configured to transmit a light beam from an optical fiber to the high-refractive-index waveguide. The dimension of the second waveguiding segment along a second direction is greater than a preset value.

### CROSS-REFERENCE TO RELATED APPLICATIONS

This is a National Stage Application, filed under 35 U.S.C. 371 based on International Patent Application No. PCT/CN2022/119226, filed on Sep. 16, 2022, which claims priority to Chinese Patent Application No. 202210335051.4 filed on Mar. 31, 2022, the disclosures of which are incorporated herein by reference in their entireties.

### TECHNICAL FIELD

The present application relates to the technical field of couplers and, in particular, to an optical waveguide coupler and a fabrication method thereof.

### BACKGROUND

An optical waveguide is the basis of an optical chip. For an integrated optical chip based on an indirect band-gap material such as a silicon film, a silicon nitride film, and a lithium niobate film, it is difficult to implement an electrically-pumped laser. An optical waveguide or a grating coupler needs to be connected to an optical fiber, a laser chip, and a detector so that a specific application is implemented. Since a significant difference exists between the mode field of the optical fiber and the mode field of a ridge waveguide (or a linear waveguide) on the chip, the overlapping degree between the modes of the two is relatively low, and a loss of more than 3 dB will be induced if the optical fiber and the waveguide are directly coupled to each other.

In the related art, the top of the waveguide on the chip is designed as a structure whose width in the longitudinal direction of the waveguide gradually changes, and a larger-dimension low-refractive-index waveguide is covered on the waveguide so that energy is coupled to the large-dimension waveguide that matches the mode field of the optical fiber and then end-surface coupling is performed with the optical fiber. However, couplers with this type of optical waveguide structures have the disadvantages of high manufacturing costs and small manufacturing tolerances, which are not conducive to mass manufacturing.

### SUMMARY

Based on this, it is necessary to provide an optical waveguide coupler and a fabrication method thereof.

According to one aspect of the present application, an optical waveguide coupler is provided.

The optical waveguide coupler includes a substrate, a high-refractive-index waveguide, and a low-refractive-index waveguide.

The high-refractive-index waveguide is formed on the substrate and includes a first waveguiding segment and a second waveguiding segment that are sequentially connected to each other and extend along a first direction, where the thickness of the second waveguiding segment gradually decreases along the first direction.

The low-refractive-index waveguide is formed on the substrate and covers the high-refractive-index waveguide.

The refractive index of the low-refractive-index waveguide is greater than the refractive index of an isolation layer of the substrate and less than the refractive index of the high-refractive-index waveguide, and the low-refractive-index waveguide is configured to transmit a light beam from an optical fiber to the high-refractive-index waveguide.

The dimension of the second waveguiding segment along a second direction is greater than a preset value.

The first direction and the second direction are perpendicular to each other and each parallel to the substrate.

In one or more embodiments, the preset value is greater than 500 nm.

In one or more embodiments, the dimension of the second waveguiding segment along the second direction is in a range of 600 to 800 nm.

In one or more embodiments, the dimension of the first waveguiding segment along the second direction is in a range of 0.6 to 3 μm.

In one or more embodiments, the low-refractive-index waveguide includes a third waveguiding segment and a fourth waveguiding segment that are sequentially connected to each other.

The third waveguiding segment is coupled to the second waveguiding segment, and the fourth waveguiding segment is in direct contact with the substrate.

In one or more embodiments, the thickness of the fourth waveguiding segment is in a range of 2 to 10 μm.

In one or more embodiments, the dimension of the fourth waveguiding segment along the second direction is in a range of 2 to 10 μm.

In one or more embodiments, the dimension of the second waveguiding segment along the first direction is in a range of 20 to 2000 μm.

In one or more embodiments, the second waveguiding segment is spaced apart from an end of the substrate.

In one or more embodiments, the material of the high-refractive-index waveguide is lithium niobate, silicon, silicon nitride, or InP, and the material of the low-refractive-index waveguide is silicon oxynitride.

In one or more embodiments, the optical waveguide coupler further includes a dielectric layer covering the high-refractive-index waveguide and the low-refractive-index waveguide.

In one or more embodiments, the refractive index of the dielectric layer is less than the refractive index of the low-refractive-index waveguide.

According to another aspect of the present application, a fabrication method of an optical waveguide coupler is provided. The fabrication method includes the steps below.

A substrate is provided.

A high-refractive-index waveguide is formed on the substrate, where the high-refractive-index waveguide includes a first waveguiding segment and a second waveguiding segment that are sequentially connected to each other and extend along a first direction, where the thickness of the second waveguiding segment gradually decreases along the first direction.

A low-refractive-index waveguide covering the high-refractive-index waveguide is formed on the substrate.

The refractive index of the low-refractive-index waveguide is greater than the refractive index of an isolation layer of the substrate and less than the refractive index of the high-refractive-index waveguide, and the low-refractive-index waveguide is configured to transmit a light beam from an optical fiber to the high-refractive-index waveguide.

The dimension of the second waveguiding segment along a second direction is greater than a preset value.

The first direction and the second direction are perpendicular to each other and each parallel to the substrate.

In one or more embodiments, the substrate includes a base and the isolation layer that are sequentially stacked, and that the high-refractive-index waveguide is formed on the substrate includes the steps below.

A high-refractive-index waveguide layer is formed on the substrate.

The surface of the high-refractive-index waveguide layer is thinned so that the thickness of the high-refractive-index waveguide layer gradually decreases along the first direction.

The high-refractive-index waveguide layer is etched to form the high-refractive-index waveguide having a ridge structure or a linear structure.

In one or more embodiments, after the low-refractive-index waveguide covering the high-refractive-index waveguide is formed on the substrate, the fabrication method further includes the step below.

A dielectric layer covering the high-refractive-index waveguide and the low-refractive-index waveguide is formed on the low-refractive-index waveguide.

When the preceding optical waveguide coupler is used, the light beam is transmitted from the optical fiber to the low-refractive-index waveguide. The second waveguiding segment and the low-refractive-index waveguide form a structure design with tapered surfaces matched with each other so that the spot size of the low-refractive-index waveguide can gradually match the mode spot of the high-refractive-index waveguide and the overlapping degree between the mode field of the low-refractive-index waveguide and the mode field of the high-refractive-index is increased. Thus, coupling efficiency can be improved and the light beam can be transmitted from the low-refractive-index waveguide to the second waveguiding segment and the first waveguiding segment successively. In addition, the dimension of the second waveguiding segment along the second direction is greater than the preset value. The preset value may be designed, according to the requirement of a manufacturing process, as a width value that is suitable for the alignment of the second waveguiding segment of the high-refractive-index waveguide with the third waveguiding segment of the low-refractive-index waveguide. Thus, the second waveguiding segment is relatively wide and can be directly prepared through ultraviolet lithography. In addition, the alignment tolerance between the second waveguiding segment and the low-refractive-index waveguide can be improved, which can effectively improve the manufacturing tolerance of the optical waveguide coupler, reduces the manufacturing cost of the optical waveguide coupler, and is conducive to the mass manufacturing of optical waveguide couplers.

### BRIEF DESCRIPTION OF DRAWINGS

To illustrate technical solutions in embodiments of the present application or the related art of the present application more clearly, the drawings used in the description of the embodiments or the related art are briefly described below. Apparently, the drawings described below illustrate only the embodiments of the present application. Those of ordinary skill in the art may obtain other drawings based on the disclosed drawings on the premise that no creative work is done.

FIG. 1 is a structural diagram of an optical waveguide coupler in one or more embodiments of the present application;

FIG. 2 is a cross-sectional side view of the portion between a CS2 cross section and a CS4 cross section of an optical waveguide coupler in one or more embodiments of the present application;

FIGS. 3A to 3E are a cross-sectional view of an optical fiber on a CS1 cross section and cross-sectional views of an optical waveguide coupler in one or more embodiments of the present application on a CS2 cross section, a CS3 cross section, a CS4 cross section, and a CS5 cross section respectively;

FIGS. 4A to 4E are a mode field diagram of an optical fiber on a CS1 cross section and mode field diagrams of an optical waveguide coupler in one or more embodiments of the present application on a CS2 cross section, a CS3 cross section, a CS4 cross section, and a CS5 cross section, respectively;

FIG. 5 is a diagram showing the distribution of the coupling efficiency of an optical fiber to a fourth waveguiding segment as varies with the width and thickness of the fourth waveguiding segment in an optical waveguide coupler in a TE0 mode in one or more embodiments of the present application;

FIG. 6 is a diagram showing a distribution of a required length of a second waveguiding segment as varies with the width and thickness of a fourth waveguiding segment when the coupling efficiency of a third waveguiding segment to the second waveguiding segment reaches 95% in an optical waveguide coupler in a TE0 mode in one or more embodiments of the present application;

FIG. 7 is a diagram showing the distribution of the coupling efficiency of a third waveguiding segment to a second waveguiding segment having a length of 200 μm as varies with the width and thickness of a fourth waveguiding segment in an optical waveguide coupler in a TE0 mode in one or more embodiments of the present application;

FIG. 8 is a diagram showing the distribution of a total coupling loss of an optical waveguide coupler in a TE0 mode as varies with the width and thickness of a fourth waveguiding segment in one or more embodiments of the present application;

FIG. 9 includes a side view and a top view showing that a third waveguiding segment is coupled to a second waveguiding segment of an optical waveguide coupler in a TE0 mode in one or more embodiments of the present application;

FIG. 10 is a graph showing an effect of an offset of a center of the core of an optical fiber in an optical waveguide coupler relative to a center of a low-refractive-index waveguide on a coupling loss in one or more embodiments of the present application;

FIG. 11 is a flowchart of a fabrication method of an optical waveguide coupler in one or more embodiments of the present application; and

FIG. 12A to 12D are schematic diagrams showing a fabrication process of an optical waveguide coupler in one or more embodiments of the present application.

### DETAILED DESCRIPTION

The preceding object, features, and advantages of the present application will be more apparent from the detailed description of the embodiments of the present application in conjunction with the drawings. Details are set forth below to facilitate a thorough understanding of the present application. However, the present application can be implemented in many manners different from the embodiments described herein, and those skilled in the art may make similar modifications without departing from the connotation of the present application, so the present application is not limited by the embodiments disclosed below.

In the description of the present application, it is to be understood that the orientation or position relationships indicated by terms “center”, “longitudinal”, “lateral”, “length”, “width”, “thickness”, “above”, “below”, “front”, “back”, “left”, “right”, “vertical”, “horizontal”, “top”, “bottom”, “inside”, “outside”, “clockwise”, “counterclockwise”, “axial”, “radial”, “circumferential”, etc. are based on the orientation or position relationships shown in the drawings, only for facilitating the description of the present application and simplifying the description, and do not indicate or imply that the apparatus or element referred to has a specific orientation and is constructed and operated in a specific orientation, and thus it is not to be construed as limiting the present application.

Moreover, terms such as “first” and “second” are used only for the purpose of description and are not to be construed as indicating or implying relative importance or implicitly indicating the number of technical features indicated. Thus, a feature defined as a “first” feature or a “second” feature may expressly or implicitly include at least one of this feature. As described herein, “multiple” is defined as at least two, for example, two, three, or the like, unless otherwise expressly and specifically limited.

In the present application, unless otherwise expressly specified and limited, the term “mounted”, “connected to each other”, “connected”, or “fixed” is to be construed in a broad sense, for example, as fixedly connected, detachably connected or integrated; mechanically connected or electrically connected; directly connected to each other or indirectly connected to each other via an intermediary; or internally connected between two components or interaction relations between two components, unless otherwise specifically limited. For those of ordinary skill in the art, specific meanings of the preceding terms in the present application may be construed according to specific situations.

In the present application, unless otherwise expressly specified and limited, when a first feature is described as “on” or “below” a second feature, the first feature and the second feature may be in direct contact or may be in indirect contact via an intermediary. Moreover, when the first feature is described as “on”, “above”, or “over” the second feature, the first feature may be right on, above, or over the second feature, the first feature may be obliquely on, above, or over the second feature, or the first feature may be simply at a higher level than the second feature. When the first feature is described as “under”, “below”, or “underneath” the second feature, the first feature may be right under, below, or underneath the second feature, the first feature may be obliquely under, below, or underneath the second feature, or the first feature may be simply at a lower level than the second feature.

It is to be noted that when a component is described as being “fixed to” or “disposed on” another component, it may be directly on the particular component, or an intermediate component may be on the particular component. When a component is described as being “connected to” another component, it may be connected to the particular component directly or through an intermediate component. The terms “vertical”, “horizontal”, “up”, “down”, “left”, “right”, and the like used herein are only used for an illustrative purpose and are not the unique embodiments.

It is to be understood that the top of a waveguide on a chip is designed as a structure whose width gradually changes in the longitudinal direction of the waveguide, resulting in the disadvantages of a high manufacturing cost and a relatively small manufacturing tolerance, which is not conducive to mass manufacturing. The inventor of the present application has found by study that the reason why a coupler with a conventional optical waveguide structure has a relatively small manufacturing tolerance is that the coupler with the conventional optical waveguide structure has a minimum line width of about 100 nm and a mask needs to be prepared and high-precision overlay needs to be performed through electron-beam lithography or deep ultraviolet lithography. However, such a small width has an extremely high requirement on a fabrication technique, resulting in a relatively small alignment tolerance of a double-layer structure during a coupling process and a high manufacturing cost.

To solve the technical problem that the coupler with the conventional optical waveguide structure has the high manufacturing cost and the relatively small manufacturing tolerance, the inventor of the present application designs a high-refractive-index waveguide after intensive studies, where the high-refractive-index waveguide includes a first waveguiding segment and a second waveguiding segment that are sequentially connected to each other and extend along a first direction. Along the first direction, the thickness of the second waveguiding segment gradually decreases, and the width of the second waveguiding segment is greater than a preset value. The low-refractive-index waveguide includes a third waveguiding segment coupled to the second waveguiding segment. With this structure, on the one hand, it can be ensured that a light beam transmitted to the third waveguiding segment can be successfully transmitted to the second waveguiding segment, and on the other hand, the preset value may be designed, according to the requirement of a manufacturing process, as a width value that is suitable for the alignment of the second waveguiding segment with the third waveguiding segment. Thus, the second waveguiding segment is relatively wide. In addition, the alignment tolerance between the second waveguiding segment and the third waveguiding segment is relatively large, which can effectively improve the manufacturing tolerance of the optical waveguide coupler and is conducive to the mass manufacturing of optical waveguide couplers.

The optical waveguide coupler in the present application is described below in detail in conjunction with embodiments.

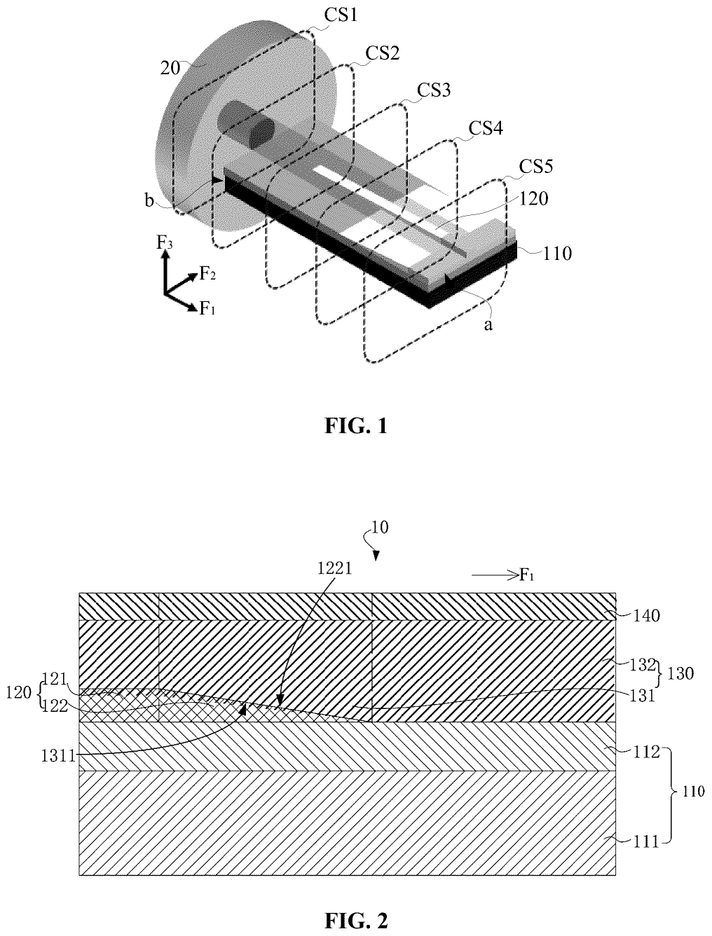

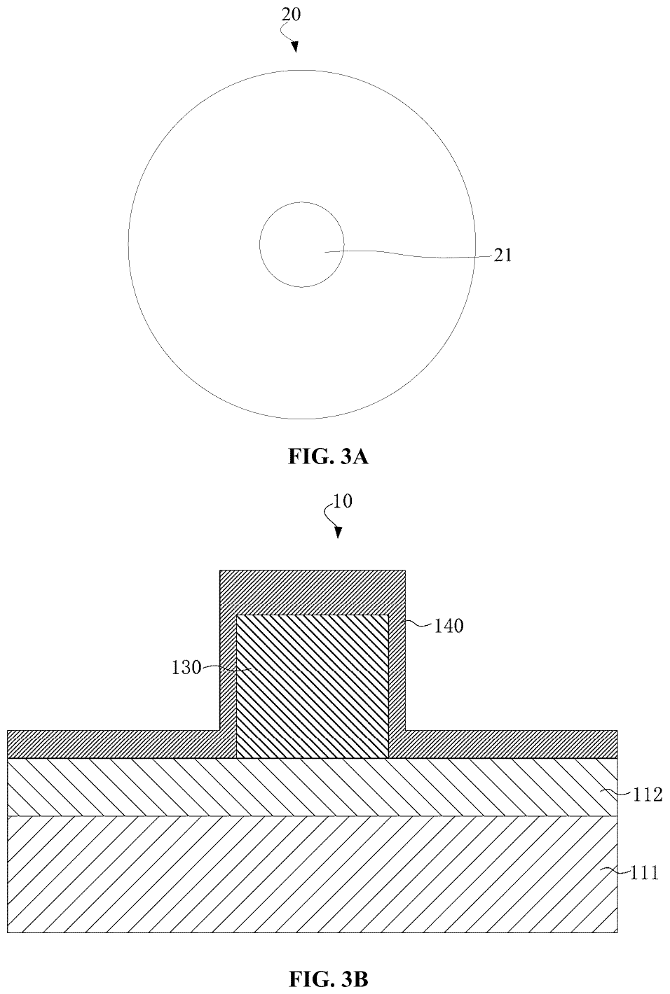

Referring to FIGS. 1 and 2 and FIGS. 3A to 3E, an optical waveguide coupler 10 provided in some embodiments of the present application includes a substrate 110, a high-refractive-index waveguide 120 formed on the substrate 110, and a low-refractive-index waveguide 130 formed on the substrate 110.

The substrate 110 has a first end a and a second end b that are disposed opposite to each other along a first direction F1.

The high-refractive-index waveguide 120 includes a first waveguiding segment 121 and a second waveguiding segment 122 that are sequentially connected to each other and extend along the first direction F1. Along the first direction F1, from the first end a of the substrate 110 to the second end b of the substrate 110, the thickness of the second waveguiding segment 122 gradually decreases so that a first bevel 1221 facing away from the substrate 110 is formed on the second waveguiding segment 122. The low-refractive-index waveguide 130 covers the high-refractive-index waveguide 120, and the second waveguiding segment 122 and the low-refractive-index waveguide 130 can form tapered-surface matching. The refractive index of the low-refractive-index waveguide 130 is greater than the refractive index of an isolation layer 112 of the substrate 110 and less than the refractive index of the high-refractive-index waveguide 120, and the low-refractive-index waveguide 130 is configured to transmit a light beam from an optical fiber 20 to the high-refractive-index waveguide 120. An end surface of the optical waveguide coupler 10 and an end surface of the optical fiber 20 are coupled to each other. When the optical waveguide coupler 10 is used, the optical fiber 20 is disposed near the second end b of the substrate 110, and the light beam is transmitted from the optical fiber 20 to the low-refractive-index waveguide 130 along the first direction F1. The second waveguiding segment 122 and the low-refractive-index waveguide 130 form a structure design with tapered surfaces matched with each other so that the spot size of the low-refractive-index waveguide 130 can gradually match the spot size of the high-refractive-index waveguide 120 and the overlapping degree between the mode field of the low-refractive-index waveguide 130 and the mode field of the high-refractive-index 120 is increased. Thus, coupling efficiency can be improved and the light beam can be transmitted from the low-refractive-index waveguide 130 to the second waveguiding segment 122 and the first waveguiding segment 121 successively.

It is to be understood that the so-called “low-refractive-index waveguide” 130 has a lower refractive index relative to the high-refractive-index waveguide 120, and the so-called “high-refractive-index waveguide” 120 has a higher refractive index relative to the low-refractive-index waveguide 130, that is, the refractive index of the high-refractive-index waveguide 120 is greater than the refractive index of the low-refractive-index waveguide 130. The low-refractive-index waveguide 130 and the high-refractive-index waveguide 120 are each continuous structure so that light propagates continuously therein.

The first waveguiding segment 121 is a region of the high-refractive-index waveguide 120 with a constant thickness. In some embodiments, the thickness of the first waveguiding segment 121 is in a range of 100 nm to 1 μm.

The second waveguiding segment 122 is a region of the high-refractive-index waveguide 120 with a gradually decreasing thickness. A maximum thickness of the second waveguiding segment 122 is equal to the thickness of the first waveguiding segment 121. In some embodiments, the thickness of the second waveguiding segment 122 evenly decreases, that is to say, the slope of the first bevel 1221 is a constant everywhere. In some embodiments, the thickness of the second waveguiding segment 122 gradually decreases to zero.

In some embodiments, an end of the second waveguiding segment 122 with a relatively small thickness is an end of the high-refractive-index waveguide 120.

In some embodiments, the high-refractive-index waveguide 120 includes two side surfaces disposed on the substrate 110 and a top surface connected to the two side surfaces separately. The two side surfaces are disposed opposite to each other. A portion of the top surface included in the first waveguiding segment 121 may be parallel to the substrate 110. A portion of the top surface included in the second waveguiding segment 122 is the first bevel 1221.

In some embodiments, the low-refractive-index waveguide 130 completely covers the two side surfaces and the top surface of the high-refractive-index waveguide 120.

In some embodiments, the dimension of the second waveguiding segment 122 along a second direction F2 may be greater than the preset value. The preset value may be designed, according to the requirement of the manufacturing process, as a width value that is suitable for the alignment of the second waveguiding segment 122 of the high-refractive-index waveguide 120 with the third waveguiding segment 131 of the low-refractive-index waveguide 130. Thus, the second waveguiding segment 122 is relatively wide and can be directly prepared through ultraviolet lithography. In addition, the alignment tolerance between the second waveguiding segment 122 and the low-refractive-index waveguide 130 can be improved, which further effectively improves the manufacturing tolerance of the optical waveguide coupler 10, reduces the manufacturing cost of the optical waveguide coupler, and is conducive to the mass manufacturing of optical waveguide couplers 10.

The second waveguiding segment 122 is relatively wide, so a time-consuming and high-cost electron-beam exposure technique may be discarded. The high-refractive-index waveguide 120 may be prepared through a lithography machine, thereby greatly reducing a fabrication cost and fabrication time.

The first direction F1 and the second direction F2 are perpendicular to each other and are each parallel to the substrate 110. Specifically, in the embodiment shown in FIG. 1, the dimension of the second waveguiding segment 122 along the first direction F1 is the dimension of the second waveguiding segment 122 along the length direction of the second waveguiding segment 122, the dimension of the second waveguiding segment 122 along the second direction F2 is the dimension of the second waveguiding segment 122 along the width direction of the second waveguiding segment 122, and the thickness of the second waveguiding segment 122 is the dimension of the second waveguiding segment 122 along a third direction F3. In some embodiments, the preset value is greater than 500 nm and the second waveguiding segment 122 of the width may be directly prepared through the ultraviolet lithography.

Of course, in some other embodiments, the dimension of the second waveguiding segment 122 along the second direction F2 may be designed to be 100 nm, which does not affect the widening of applications of the optical waveguide coupler and the fabrication method thereof of the present application.

Optionally, the material of the high-refractive-index waveguide 120 includes an optical waveguide medium such as lithium niobate, silicon, silicon nitride, or InP. The high-refractive-index waveguide 120 may be a wire waveguide or a ridge waveguide, which is not specifically limited here.

Optionally, the low-refractive-index waveguide 130 may be a silicon oxynitride waveguide.

In some embodiments, the first waveguiding segment 121 of the high-refractive-index waveguide 120 is disposed near the first end a of the substrate 110. Specifically, an end of the first waveguiding segment 121 in the first direction F1 may be aligned with the first end a.

In some embodiments, the second waveguiding segment 122 of the high-refractive-index waveguide 120 is spaced apart from the second end b of the substrate 110. That is to say, in the first direction F1, the length of the high-refractive-index waveguide 120 is less than the length of the substrate 110. The low-refractive-index waveguide 130 covers not only the high-refractive-index waveguide 120 but also the part of the substrate 110 between the second waveguiding segment 122 and the second end b of the substrate 110.

In some embodiments, the low-refractive-index waveguide 130 includes a third waveguiding segment 131 and a fourth waveguiding segment 132 that are sequentially connected to each other, the third waveguiding segment 131 is coupled to the second waveguiding segment 122, and the fourth waveguiding segment 132 is in direct contact with the substrate 110. A second bevel 1311 matching the first bevel 1221 is formed on the third waveguiding segment 131. In the first direction F1 from the first end a to the second end b, the thickness of the third waveguiding segment 131 gradually increases. Then, the low-refractive-index waveguide 130 and the high-refractive-index waveguide 120 perform energy exchange by means of the second waveguiding segment 122 and the third waveguiding segment 131 with gradually changing thicknesses so that the low-refractive-index waveguide 130 is optically coupled to the high-refractive-index waveguide 120. In some embodiments, an end of the fourth waveguiding segment 132 in the first direction F1 may be aligned with the second end b of the substrate 110. In some embodiments, a TE0 fundamental mode and a TM0 fundamental mode in the optical fiber 20 may be separately coupled to a waveguide fundamental mode corresponding to the fourth waveguiding segment 132 of the lower-refractive-index waveguide 130 so that it is ensured that the fourth waveguiding segment 132 can transmit the light beam from the optical fiber 20 to the high-refractive-index waveguide 120.

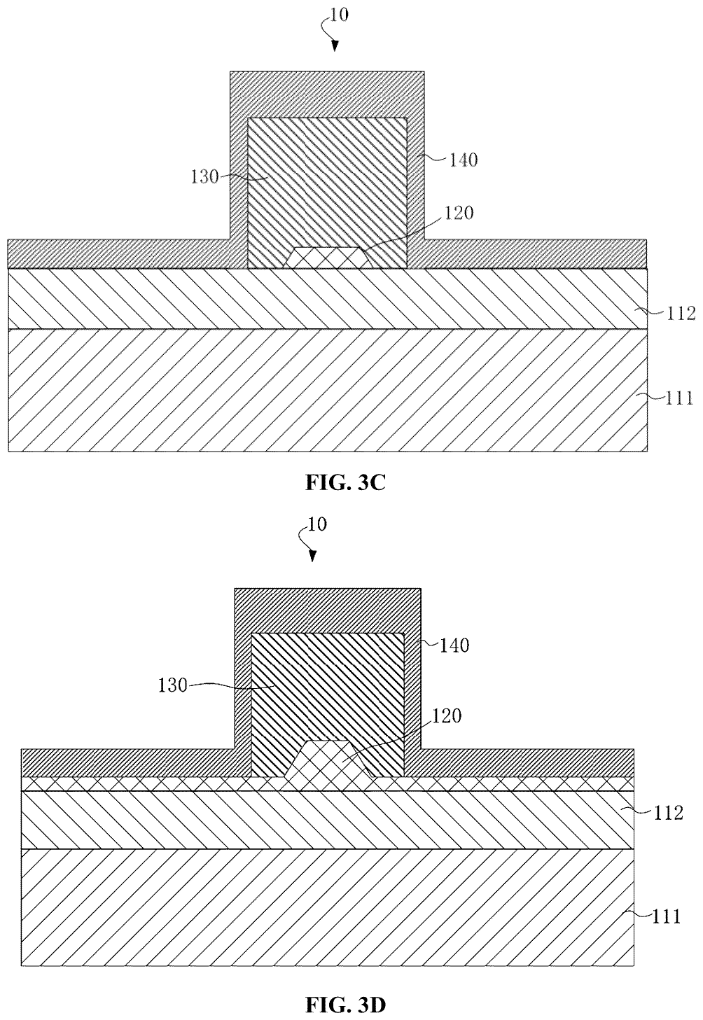

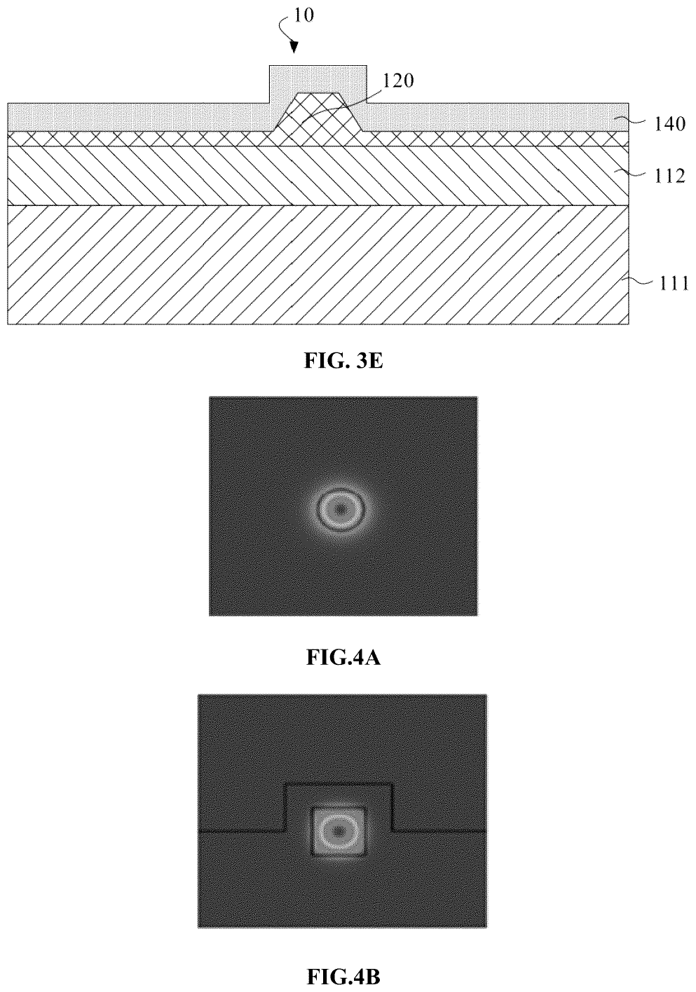

Specifically, in the embodiments shown in FIGS. 3A to 3E and FIGS. 4A to 4E, the low-refractive-index waveguide 130 is the silicon oxynitride waveguide, the high-refractive-index waveguide 120 is a lithium niobate ridge waveguide, and the TE0 fundamental mode in the optical fiber 20 is coupled to the waveguide fundamental mode corresponding to the fourth waveguiding segment 132 so that the TE0 mode in the optical fiber 20 is coupled to the low-refractive-index waveguide 130 which has a similar mode volume, and the low-refractive-index waveguide 130 performs the energy exchange with the high-refractive-index waveguide 120 by means of the second waveguiding segment 122 with gradually changing thickness.

FIGS. 3A to 3E are a cross-sectional view of the optical fiber 20 on a CS1 cross section and cross-sectional views of the optical waveguide coupler 10 on a CS2 cross section, a CS3 cross section, a CS4 cross section, and a CS5 cross section, respectively (each of the CS1 cross section, the CS2 cross section, the CS3 cross section, the CS4 cross section, and the CS5 cross section is perpendicular to the longitudinal direction of the substrates 110). FIGS. 4A to 4E are a mode field diagram of the optical fiber 20 on the CS1 cross section and mode field diagrams of the optical waveguide coupler 10 on the CS2 cross section, the CS3 cross section, the CS4 cross section, and the CS5 cross section respectively. It can be learned from FIGS. 3A to 3E and FIGS. 4A to 4E that a TE0 mode in the low-refractive-index waveguide 130 is gradually coupled to a TE0 mode in the high-refractive-index waveguide 120. This also indicates that the second waveguiding segment 122 and the low-refractive-index waveguide 130 form the structure design with the tapered surfaces matched with each other so that the spot size of the low-refractive-index waveguide 130 can gradually match the mode spot of the high-refractive-index waveguide 120. In addition, the TE0 coupling and the TM0 coupling on the optical waveguide coupler 10 are simulated through analog optical simulation software (such as Lumerical), and it can be learned that a TE0 coupling loss is as low as 0.30 dB and a TM0 coupling loss is as low as 0.19 dB. This also indicates that the overlapping degree between the mode field of the low-refractive-index waveguide 130 and the mode field of the high-refractive-index 120 can be well increased through the optical waveguide coupler 10 in the present application, thereby implementing the low-loss energy transmission between the high-refractive-index waveguide 130 and the optical fiber 20.

Optionally, a high-refractive-index optical fiber (UHNA7) may be used as the optical fiber 20. The numeric aperture of the high-refractive-index optical fiber NA is equal to 0.41, the refractive index of the core of the high-refractive-index optical fiber is 1.519172, and the refractive index of silicon oxynitride is 1.56. The refractive index of the core of the high-refractive-index optical fiber is similar to the refractive index of the silicon oxynitride so that the mode spots of the two can be well matched with each other, which is conducive to transmitting the light beam from the optical fiber 20 to the fourth waveguiding segment 132 of the low-refractive-index waveguide 130.

In some embodiments, the dimension of the second waveguiding segment 122 along the second direction F2 is in a range of 600 nm to 800 nm. That is to say, the width of the second waveguiding segment 122 is in a range of 600 nm to 800 nm so that it is convenient for a device such as the lithography machine to obtain the second waveguiding segment 122 of the width.

In some embodiments, the dimension of the first waveguiding segment 121 along the second direction F2 is in a range of 0.6 to 3 μm, that is to say, the width of the first waveguiding segment 121 is in a range of 0.6 to 3 μm, which can ensure that the optical waveguide coupler 10 obtains a better coupling effect.

In some embodiments, the thickness of the fourth waveguiding segment 132 is in a range of 2 to 10 μm. The thickness of the fourth waveguiding segment 132 is controlled at 2 to 10 μm, which can ensure that the optical waveguide coupler 10 obtains a better coupling effect. In some embodiments, the height of the third waveguiding segment 131 is equal to the height of the fourth waveguiding segment 132. That is to say, the sum of the thickness of the third waveguiding segment 131 and the thickness of the second waveguiding segment 122 at the same position of the substrate 110 is equal to the thickness of the fourth waveguiding segment 132.

In some embodiments, the dimension of the fourth waveguiding segment 132 along the second direction F2 is in a range of 2 to 10 μm, that is to say, the width of the fourth waveguiding segment 132 is in a range of 2 to 10 μm. The width of the fourth waveguiding segment 132 is controlled at 2 to 10 μm, which can ensure that the optical waveguide coupler 10 obtains a better coupling effect.

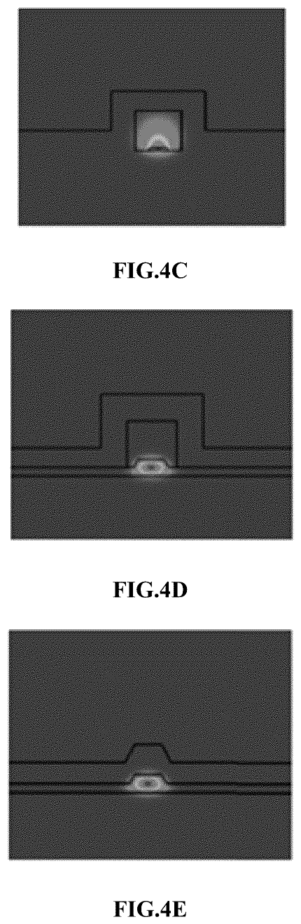

Illustratively, in the embodiment shown in FIG. 5, the low-refractive-index waveguide 130 is the silicon oxynitride waveguide, the high-refractive-index waveguide 120 is the lithium niobate ridge waveguide, and the TE0 fundamental mode in the optical fiber 20 is coupled to the waveguide fundamental mode corresponding to the fourth waveguiding segment 132. FIG. 5 shows a changing trend of the coupling efficiency of the optical fiber 20 to the fourth waveguiding segment 132 as varies with the thickness of the fourth waveguiding segment 132 in the TE0 mode. In the left diagram of FIG. 5, a horizontal coordinate corresponds to the thickness of the fourth waveguiding segment 132, and a vertical coordinate corresponds to the width of the fourth waveguiding segment 132. The right diagram of FIG. 5 is a color chart corresponding to different coupling efficiency in the left diagram of FIG. 5. In conjunction with the left and right diagrams of FIG. 5, it can be learned that the coupling efficiency of the fourth waveguiding segment 132 to the optical fiber changes along with different selected thicknesses and widths of the fourth waveguiding segment 132. When the thickness of the fourth waveguiding segment 132 is 3.4 μm and the width of the fourth waveguiding segment 132 is 3.5 μm, the coupling efficiency of the fourth waveguiding segment 132 to the optical fiber 20 reaches 97%.

In some embodiments, the dimension of the second waveguiding segment 122 along the first direction F1 is in a range of 20 to 2000 μm, that is to say, the length of the second waveguiding segment 122 is in a range of 20 to 2000 μm. If the second waveguiding segment 122 is too short, to ensure that the third waveguiding segment 131 and the second waveguiding segment 122 perform the energy exchange and are well coupled to each other, the low-refractive-index waveguide 130 with a relatively small cross-sectional area is required. Consequently, the low-refractive-index waveguide 130 is not enough to be efficiently coupled to the optical fiber, which is not conducive to improving total coupling efficiency. If the second waveguiding segment 122 is too long, the second waveguiding segment 122 is not conducive to processing and manufacturing. Therefore, the length of the second waveguiding segment 122 is preferably controlled within a range of 60 to 200 μm, which is conducive to the processing and the manufacturing and can improve the total coupling efficiency.

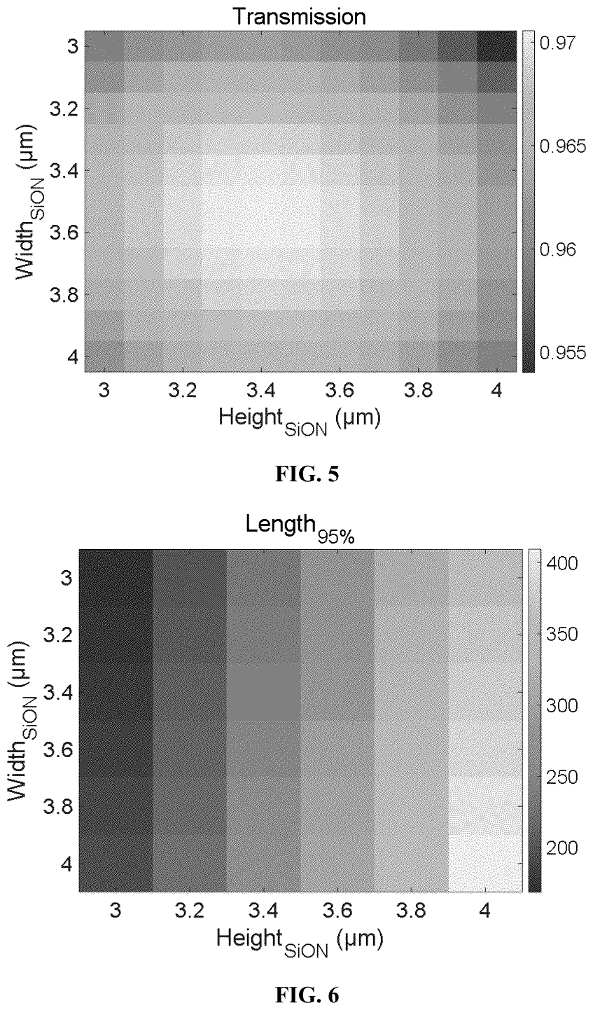

Illustratively, in the embodiment shown in FIG. 6, the low-refractive-index waveguide 130 is the silicon oxynitride waveguide, the high-refractive-index waveguide 120 is the lithium niobate ridge waveguide, and the TE0 fundamental mode in the third waveguiding segment 131 is coupled to a waveguide fundamental mode corresponding to the second waveguiding segment 122. The left diagram of FIG. 6 shows a diagram of required lengths of the second waveguiding segment 122 when energy is coupled from the third waveguiding segment 131 to the second waveguiding segment 122 as varies with different thicknesses and widths of the fourth waveguiding segment 132. The right diagram of FIG. 6 shows a color chart corresponding to different required lengths of the second waveguiding segment 122. When both the thickness and width of the fourth waveguiding segment 132 are 3 μm, the required length of the second waveguiding segment 122 is the shortest. In this case, the length of the second waveguiding segment 122 is less than 200 μm, which is the easiest for fabrication and coupling efficiency can reach 95%.

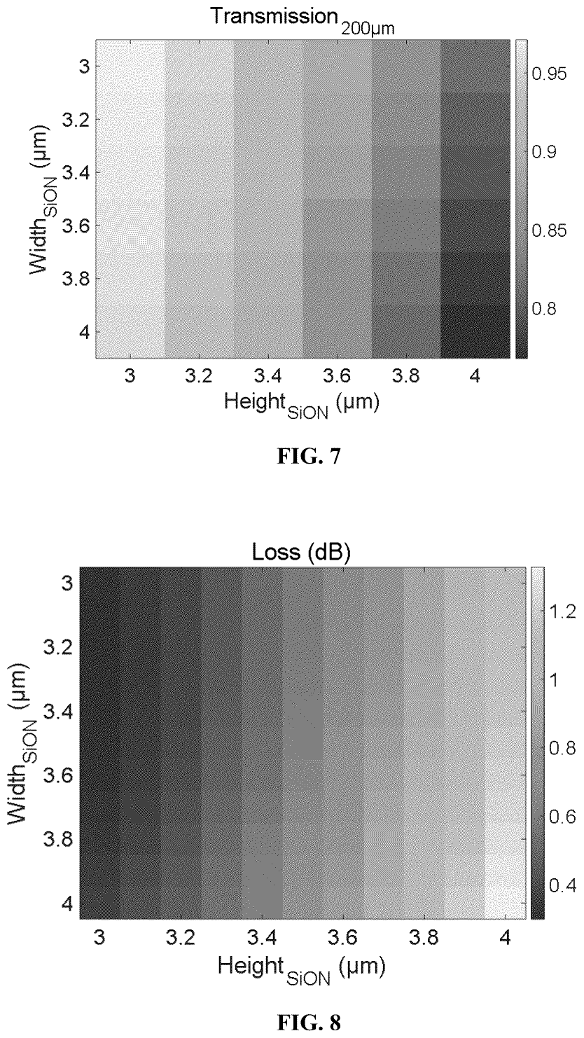

Illustratively, in the embodiment shown in FIG. 7, the low-refractive-index waveguide 130 is the silicon oxynitride waveguide, the high-refractive-index waveguide 120 is the lithium niobate ridge waveguide, and the length of the second waveguiding segment 122 is 200 μm, the TE0 fundamental mode in the optical fiber 20 is coupled to a waveguide fundamental mode corresponding to the third waveguiding segment 131, and the thickness and width of the fourth waveguiding segment 132 are each set to a range of 3 to 4 μm. FIG. 7 shows a changing trend of the coupling efficiency of the third waveguiding segment 131 to the second waveguiding segment 122 as varies with the thickness and width of the fourth waveguiding segment 132 in the TE0 mode. It can be learned from FIG. 7 that the smaller the thickness and width of the fourth waveguiding segment 132, the higher the coupling efficiency of the third waveguiding segment 131 to the second waveguiding segment 122 in the TE0 mode. However, when both the width and thickness of the fourth waveguiding segment 132 are 3 μm, the coupling efficiency of the third waveguiding segment 131 to the second waveguiding segment 122 in the TE0 mode may be higher than 95%. The fourth waveguiding segment 132 of appropriate dimensions can be used based on comprehensive consideration of the convenience of the manufacturing process and the total coupling efficiency, that is, the low-refractive-index waveguide 130 of appropriate dimensions can be used.

It is to be noted that the total coupling efficiency is equal to the product of the coupling efficiency of the optical fiber to the low-refractive-index waveguide 130 and the coupling efficiency of the low-refractive-index waveguide 130 to the high-refractive-index waveguide 120.

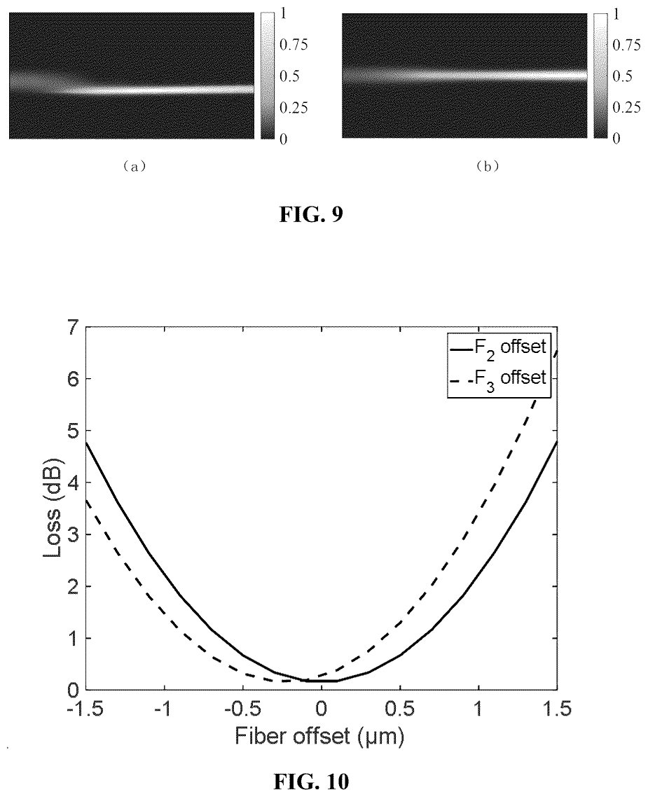

Illustratively, in the embodiment shown in FIG. 8, the TE0 fundamental mode in the optical fiber 20 is coupled to the waveguide fundamental mode corresponding to the second waveguiding segment 122. FIG. 8 shows a diagram of a total coupling loss as varies with the thickness and the width of the fourth waveguiding segment 132 in the TE0 mode. It may be learned from FIG. 8 that when the width of the fourth waveguiding segment 132 is 3.3 μm and the thickness of the fourth waveguiding segment 132 is 3 μm, the coupling loss is the lowest.

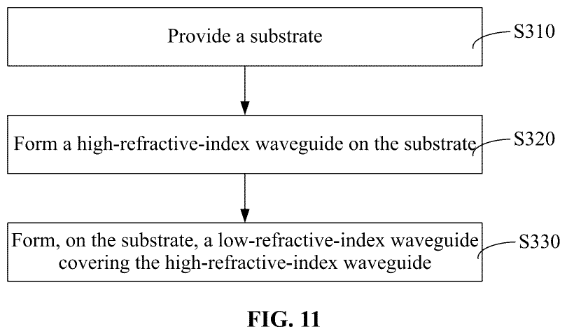

Illustratively, in the embodiment shown in FIG. 9, the low-refractive-index waveguide 130 is the silicon oxynitride waveguide, the high-refractive-index waveguide 120 is a lithium niobate waveguide, and the length of the second waveguiding segment 122 is 200 μm. The diagram (a) and the diagram (b) of FIG. 9 are a side view and a top view showing that the third waveguiding segment 131 is coupled to the second waveguiding segment 122 in the TE0 mode, respectively. It may be learned that almost all the energy of the TE0 in the silicon oxynitride waveguide is transferred to the high-refractive-index waveguide 120.

The coupling of the TM0 fundamental mode is similar to that of the TE0 fundamental mode.

In some embodiments, the dimension of the second waveguiding segment 122 along the first direction F1 is in a range of 60 to 80 μm, that is to say, the length of the second waveguiding segment 122 is in a range of 60 to 80 μm. This is a compromise between the coupling efficiency and difficulty in fabrication.

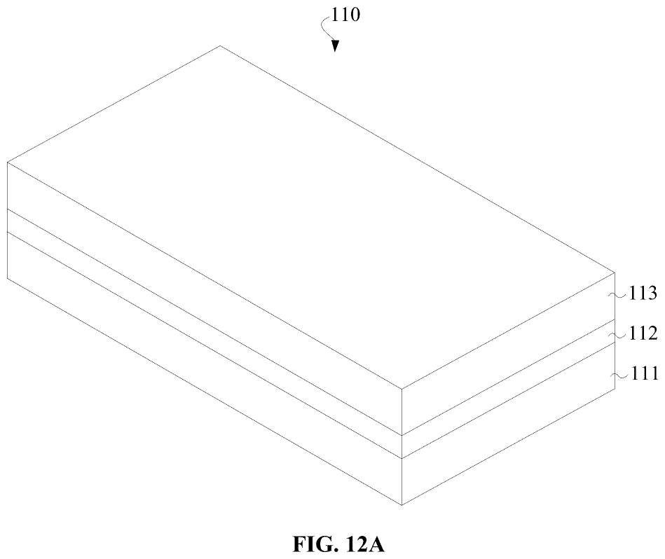

As shown in FIG. 10, the larger the offset of the center of the core 21 of the optical fiber 20 relative to the center of the low-refractive-index waveguide 130, the higher the coupling loss. For the reduction of the coupling loss, the center of the low-refractive-index waveguide 130 may be aligned with the center of the core 21 of the optical fiber 20 during use.

In some embodiments, the optical waveguide coupler 10 further includes a dielectric layer 140. The dielectric layer 140 covers the surface of the high-refractive-index waveguide 120 and the surface of the low-refractive-index waveguide 130, thereby covering the high-refractive-index waveguide 120 and the low-refractive-index waveguide 130. The dielectric layer 140 forms a cladding layer of the high-refractive-index waveguide 120 and the low-refractive-index waveguide 130, reducing a loss of light during transmission on the high-refractive-index waveguide 120 and the low-refractive-index waveguide 130. The refractive index of the dielectric layer 140 is less than the refractive index of the low-refractive-index waveguide 130. The material of dielectric layer 140 may be, for example, silicon dioxide.

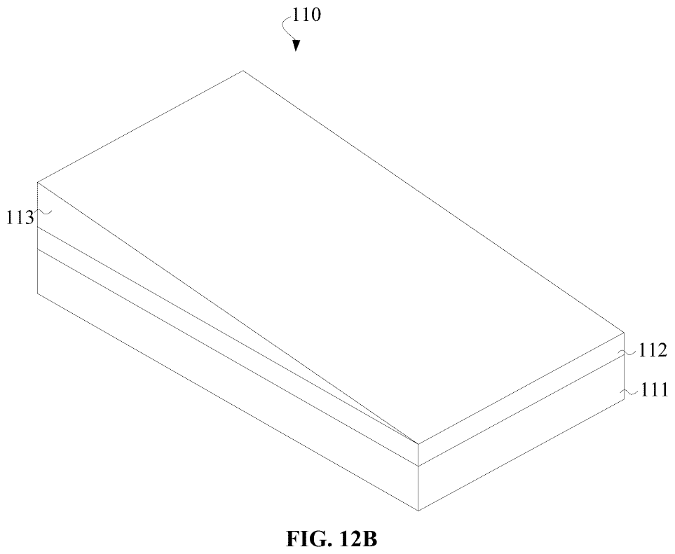

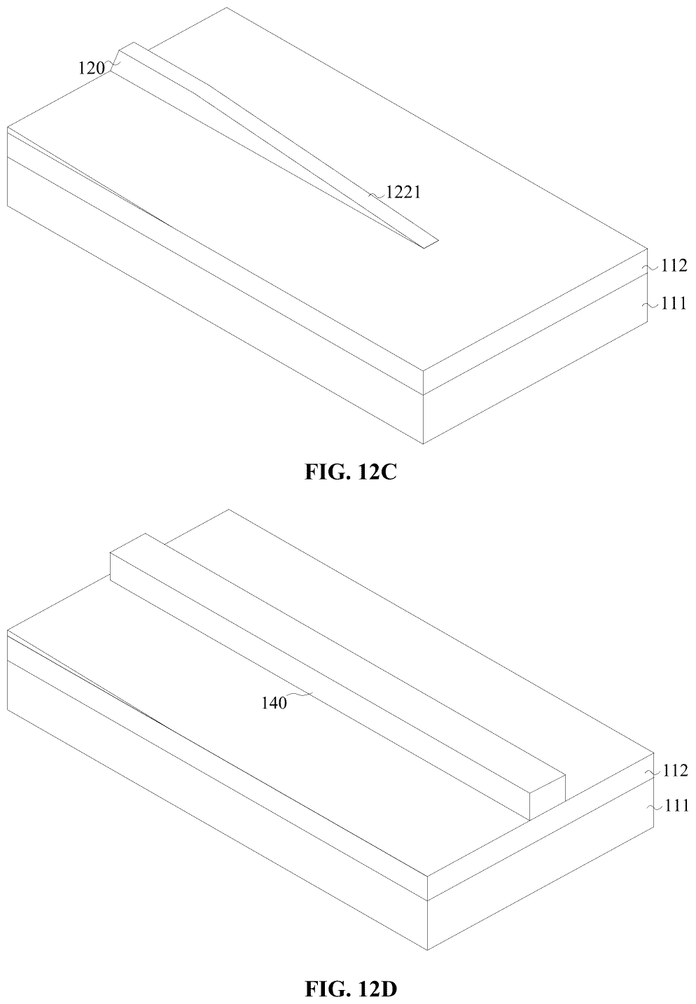

Referring to FIG. 11 and FIGS. 12A to 12D, a fabrication method of an optical waveguide coupler 10 is provided in some embodiments of the present application, and the method includes steps S310 to S330.

In S310, a substrate 110 is provided.

In S320, a high-refractive-index waveguide 120 is formed on the substrate 110. The high-refractive-index waveguide 120 includes a first waveguiding segment 121 and a second waveguiding segment 122 that are sequentially connected to each other and extend along a first direction F1. Along the first direction F1, from a first end a of the substrate 110 to a second end b of the substrate 110, the thickness of the second waveguiding segment 122 decreases gradually so that a first bevel 1221 facing away from the substrate 110 is formed on the second waveguiding segment 122.

In S330, a low-refractive-index waveguide 130 covering the high-refractive-index waveguide 120 is formed on the substrate 110. The low-refractive-index waveguide 130 includes a third waveguiding segment 131 and a fourth waveguiding segment 132 that are sequentially connected to each other, where the third waveguiding segment 131 is coupled to the second waveguiding segment 122 and has a second bevel 1311 matching the first bevel 1221.

The refractive index of the low-refractive-index waveguide 130 is between the refractive index of an isolation layer 112 of the substrate 110 and the refractive index of the high-refractive-index waveguide 120, and the low-refractive-index waveguide 130 is configured to transmit a light beam from an optical fiber 20 to the high-refractive-index waveguide 120. The dimension of the second waveguiding segment 122 along a second direction F2 may be greater than 500 nm, that is, the width of the second waveguiding segment 122 may be greater than 500 nm. When the optical waveguide coupler 10 is used, the light beam is transmitted from the optical fiber 20 to the fourth waveguiding segment 132 along the first direction F1 and transmitted from the fourth waveguiding segment 132 to the second waveguiding segment 122 via the third waveguiding segment 131. The second waveguiding segment 122 and the third waveguiding segment 131 form a structure design with tapered surfaces matched with each other so that the spot size of the low-refractive-index waveguide 130 can gradually match the mode spot of the high-refractive-index waveguide 120 and the overlapping degree between the mode field of the low-refractive-index waveguide 130 and the mode field of the high-refractive-index 120 is increased. Thus, coupling efficiency can be improved and the light beam can be transmitted from the low-refractive-index waveguide 130 to the second waveguiding segment 122 and the first waveguiding segment 121 successively so that the optical waveguide coupler 10 is applied to a film photonic chip made of silicon, silicon nitride, aluminum nitride, or the like. Therefore, with the fabrication method of the optical waveguide coupler 10, the overlapping degree between the mode field of the low-refractive-index waveguide 130 and the mode field of the high-refractive-index 120 can be increased, thereby improving the coupling efficiency. In addition, the alignment tolerance between the second waveguiding segment 122 and the third waveguiding segment 131 can be caused to be relatively large, which can effectively improve the manufacturing tolerance of the optical waveguide coupler 10 and is conducive to the mass manufacturing of optical waveguide couplers 10.

In some embodiments, referring to FIGS. 3A to 3E and FIGS. 12A to 12D, the substrate 110 includes a base 111 and the isolation layer 112 that are sequentially stacked, and that the high-refractive-index waveguide 120 is formed on the substrate 110 includes steps S321 to S323.

In S321, a high-refractive-index waveguide layer 113 is formed on the substrate 110.

In S322, the surface of the high-refractive-index waveguide layer 113 is thinned so that the thickness of the high-refractive-index waveguide layer 113 gradually decreases along the first direction F1. In some embodiments, the surface of the high-refractive-index waveguide layer 113 may be unevenly thinned. Optionally, the surface of the high-refractive-index waveguide layer 113 may be thinned through polishing, lithography, or the like.

In S323, the lithography is performed on the high-refractive-index waveguide layer 113 so that the high-refractive-index waveguide layer 113 is etched into the high-refractive-index waveguide 120 having a ridge structure or a linear structure.

Since the second waveguiding segment 122 is relatively wide, a stepper lithography machine may be used for performing the lithography on the high-refractive-index waveguide layer 113 so that the high-refractive-index waveguide 120 is obtained. Thus, a time-consuming and high-cost electron-beam exposure technique may be discarded. The stepper lithography machine may be used for performing I-line (365 nm) ultraviolet lithography, which can save fabrication time and a fabrication cost, is highly repeatable, and is applicable to mass production. On the premise that the coupling efficiency is ensured, new possibilities are provided for the coupling and encapsulation of end surfaces of an integrated lithium niobate platform.

It is to be noted that in the process where the lithography machine may be used for performing the lithography on the high-refractive-index waveguide layer 113, each of the two sidewalls of the high-refractive-index waveguide 120 along the width direction of the high-refractive-index waveguide 120 is typically disposed at an acute angle with the horizontal plane, which is formed by a mask of the lithography.

Optionally, the material of the base 111 may be silicon or sapphire, the material of the isolation layer 112 may be silicon dioxide, and the material of the high-refractive-index waveguide layer 113 includes an optical waveguide medium such as lithium niobate, silicon, silicon nitride, or InP, which is not specifically limited here.

In some embodiments, referring to FIGS. 3A to 3E, after the low-refractive-index waveguide 130 covering the high-refractive-index waveguide 120 is formed on the substrate 110, the fabrication method of the optical waveguide coupler 10 further includes the step below.

A dielectric layer 140 covering the high-refractive-index waveguide 120 and the low-refractive-index waveguide 130 is formed on the low-refractive-index waveguide 130. The dielectric layer 140 forms a cladding layer of the high-refractive-index waveguide 120 and the low-refractive-index waveguide 130, reducing a loss of light during transmission on the high-refractive-index waveguide 120 and the low-refractive-index waveguide 130. Optionally, the refractive index of the dielectric layer 140 is less than the refractive index of the low-refractive-index waveguide 130. The material of the dielectric layer 140 may be silicon dioxide, another material having a first refractive index (the first refractive index refers to a refractive index less than that of the low-refractive-index waveguide 130), or the like. The dielectric layer 140 may be formed through chemical vapor deposition (CVD), high-density plasma chemical vapor deposition (HDPCVD), spin-on-glass (SOG), physical vapor deposition (PVD), or another suitable method, which is not specifically limited here.

In some other embodiments, no dielectric layer 140 may be disposed, and the top surface of the low-refractive-index waveguide 130 may be in direct contact with the air.

The technical features of the preceding embodiments may be combined in any manner. For brevity of description, all possible combinations of the technical features in the preceding embodiments are not described. However, as long as the combinations of these technical features do not conflict, such combinations are to be construed as being within the scope of the specification. The preceding embodiments are only several implementation manners of the present application. These embodiments are described in a specific and detailed manner but cannot be understood as a limit to the scope of the present application. It is to be noted that for those having ordinary skill in the art, several modifications and improvements may further be made without departing from the concept of the present application, and these modifications and improvements are within the scope of the present application. Therefore, the scope of the present application is defined by the appended claims.

1. An optical waveguide coupler, comprising:
a substrate;
a high-refractive-index waveguide formed on the substrate and comprising a first waveguiding segment and a second waveguiding segment that are sequentially connected to each other and extend along a first direction, wherein a thickness of the second waveguiding segment gradually decreases along the first direction; and
a low-refractive-index waveguide formed on the substrate and covering the high-refractive-index waveguide, wherein a refractive index of the low-refractive-index waveguide is greater than a refractive index of an isolation layer of the substrate and less than a refractive index of the high-refractive-index waveguide, and the low-refractive-index waveguide is configured to transmit a light beam from an optical fiber to the high-refractive-index waveguide;
wherein a dimension of the second waveguiding segment along a second direction is greater than a preset value; and
the first direction and the second direction are perpendicular to each other and each parallel to the substrate.

2. The optical waveguide coupler according to claim 1, wherein the preset value is greater than 500 nm.

3. The optical waveguide coupler according to claim 1, wherein the dimension of the second waveguiding segment along the second direction is in a range of 600 to 800 nm.

4. The optical waveguide coupler according to claim 1, wherein a dimension of the first waveguiding segment along the second direction is in a range of 0.6 to 3 μm.

5. The optical waveguide coupler according to claim 1, wherein the low-refractive-index waveguide comprises a third waveguiding segment and a fourth waveguiding segment that are sequentially connected to each other;
wherein the third waveguiding segment is coupled to the second waveguiding segment, and the fourth waveguiding segment is in direct contact with the substrate.

6. The optical waveguide coupler according to claim 5, wherein a thickness of the fourth waveguiding segment is in a range of 2 to 10 μm.

7. The optical waveguide coupler according to claim 5, wherein a dimension of the fourth waveguiding segment along the second direction is in a range of 2 to 10 μm.

8. The optical waveguide coupler according to claim 1, wherein a dimension of the second waveguiding segment along the first direction is in a range of 20 to 2000 μm.

9. The optical waveguide coupler according to claim 1, wherein the second waveguiding segment is spaced apart from an end of the substrate.

10. The optical waveguide coupler according to claim 1, wherein a material of the high-refractive-index waveguide is lithium niobate, silicon, silicon nitride, or InP, and a material of the low-refractive-index waveguide is silicon oxynitride.

11. The optical waveguide coupler according to claim 1, further comprising a dielectric layer covering the high-refractive-index waveguide and the low-refractive-index waveguide.

12. The optical waveguide coupler according to claim 11, wherein a refractive index of the dielectric layer is less than the refractive index of the low-refractive-index waveguide.

13. A fabrication method of an optical waveguide coupler, comprising:
providing a substrate;
forming a high-refractive-index waveguide on the substrate, wherein the high-refractive-index waveguide comprises a first waveguiding segment and a second waveguiding segment that are sequentially connected to each other and extend along a first direction, wherein a thickness of the second waveguiding segment gradually decreases along the first direction; and
forming, on the substrate, a low-refractive-index waveguide covering the high-refractive-index waveguide;
wherein a refractive index of the low-refractive-index waveguide is greater than a refractive index of an isolation layer of the substrate and less than a refractive index of the high-refractive-index waveguide, and the low-refractive-index waveguide is configured to transmit a light beam from an optical fiber to the high-refractive-index waveguide;
a dimension of the second waveguiding segment along a second direction is greater than a preset value; and
the first direction and the second direction are perpendicular to each other and each parallel to the substrate.

14. The fabrication method of the optical waveguide coupler according to claim 13, wherein the substrate comprises a base and the isolation layer that are sequentially stacked, and forming the high-refractive-index waveguide on the substrate comprises:
forming a high-refractive-index waveguide layer on the substrate;
thinning a surface of the high-refractive-index waveguide layer so that a thickness of the high-refractive-index waveguide layer gradually decreases along the first direction; and
etching the high-refractive-index waveguide layer to form the high-refractive-index waveguide having a ridge structure or a linear structure.

15. The fabrication method of the optical waveguide coupler according to claim 13, wherein after forming, on the substrate, the low-refractive-index waveguide covering the high-refractive-index waveguide, the fabrication method further comprises:
forming, on the low-refractive-index waveguide, a dielectric layer covering the high-refractive-index waveguide and the low-refractive-index waveguide.

16. The optical waveguide coupler according to claim 5, wherein a dimension of the second waveguiding segment along the first direction is in a range of 20 to 2000 μm.

17. The optical waveguide coupler according to claim 5, wherein the second waveguiding segment is spaced apart from an end of the substrate.

18. The optical waveguide coupler according to claim 5, wherein a material of the high-refractive-index waveguide is lithium niobate, silicon, silicon nitride, or InP, and a material of the low-refractive-index waveguide is silicon oxynitride.

19. The optical waveguide coupler according to claim 5, further comprising a dielectric layer covering the high-refractive-index waveguide and the low-refractive-index waveguide.

20. The optical waveguide coupler according to claim 19, wherein a refractive index of the dielectric layer is less than the refractive index of the low-refractive-index waveguide.
